(19) United States
(12) Patent Application Publication
(10) Pub. No.: US 2009/0120255 A1
(43) Pub. Date: May 14, 2009

(54) Micro-adjustable fence device for a cutting machine

(75) Inventor: Kuan-Hui Lee, Taichung City (TW)

Correspondence Address: K&L Gates LLP, STATE STREET FINANCIAL CENTER, One Lincoln Street, BOSTON, MA, 02111-2950, US

(73) Assignee: P&F Brother Industrial Corporation, Taichung (TW)

(21) Appl. No.: 11/983,223

(22) Filed: Nov. 8, 2007

(51) Int. Cl. B26D 7/06

(52) U.S. Cl. 83/438; 269/315

(57) ABSTRACT

A micro-adjustable fence device includes a fence and a carriage. The carriage is mounted to the fence, and has a chassis body with a major wall surface that has a longitudinally extending riding route to guide the major wall surface to slidably ride on a guiding rail of a cutting machine. A wheel includes a hub rotatably mounted relative to the chassis body and defining a hub center, and a rim disposed to be shiftable betweena traction gaining position, where the rim frictionally contacts the guiding rail at a tangential point so as to roll thereon, and an idle position, where the rim is disengaged from the guiding rail. The tangential point is in line with an advancing path of the hub center. A biasing member is disposed to bias the hub to move towards the idle position.

### BACKGROUND OF THE INVENTION

1. Field of the Invention

This invention relates to a fence device for a cutting machine, more particularly to a fence device with a micro-adjusting mechanism for precisely positioning a fence.

2. Description of the Related Art

A fence device is generally used for positioning a workpiece on a tabletop of a cutting machine, such as a table saw. The fence device extends across the tabletop, and is movable longitudinally so as to define a desired cutting length of the workpiece, i.e., the distance between the fence device and a circular saw. Micro-movement of the fence device is required when the cut length of the workpiece is quite close to the desired cutting length. Hence, a micro-adjusting mechanism is provided to move the fence device through a small distance for precise adjustment.

Referring to FIG. 1, a conventional fence device includes a carriage 1, a fence 2 mounted to a middle portion of the carriage 1, and a handle 3 disposed on a side portion of the carriage 1. The carriage 1 has a longitudinally extending riding groove 101 that permits sliding movement of the carriage 1 along a guiding rail 4 on a worktable of a cutting machine. A micro-adjusting mechanism 10 is disposed on a bottom of the carriage 1, and includes a suspending arm 11 which has a fixed end 111 secured on the carriage 1 by means of two screws 12, and a projecting end 112 with a wheel 13 that is pivoted thereto and that is biased away from the guiding rail 4. During a micro-adjustment of the fence device, the operator forces the projecting end 112 of the suspending arm 11 to move toward the guiding rail 4 so as to angular move the wheel 13 relative to the fixed end 111 and so as to frictionally contact the guiding rail 4, and subsequently rotates the wheel 13 on the guiding rail 4 so as to permit micro-movement of the fence device along the guiding rail 4. However, as a pressing force applied to the carriage 1 is uneven, and as a great torque will generate as a result of operation of the wheel 13, the suspending arm 11 may suffer from elastic fatigue, or may be broken after a prolonged period of use.

### SUMMARY OF THE INVENTION

The object of the present invention is to provide a micro-adjustable fence device for a cutting machine, which can be easily operated to apply an even frictional force to a guiding rail for micro-adjustment of the position of a fence.

According to this invention, the micro-adjustable fence device includes a fence which has front and rear ends and which is movable in a longitudinal direction, and a carriage which is mounted to the fence proximate to the front end. The carriage has a chassis body which has a major wall surface confronting a guiding rail of a cutting machine. The major wall surface extends in a first transverse direction and forwardly of the guiding rail to terminate at a fore end. The major wall surface has a riding route therein which extends in the longitudinal direction to guide the major wall surface to slidably ride on the guiding rail so as to permit movement of the fence. A wheel includes a hub which is rotatably mounted relative to the chassis body about a rotating axis in a second transverse direction, and which defines a hub center in the rotating axis, and a rim which is manually turnable about the rotating axis, and which is disposed to be shiftable between a traction gaining position, where the rim frictionally contacts the guiding rail at a tangential point so as to roll thereon, and an idle position, where the rim is disengaged from the guiding rail. The tangential point is in line with an advancing path of the hub center when the rim shifts from the idle position to the traction gaining position. A biasing member is disposed to bias the hub to move towards the idle position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary bottom perspective view of a conventional micro-adjustable fence device;

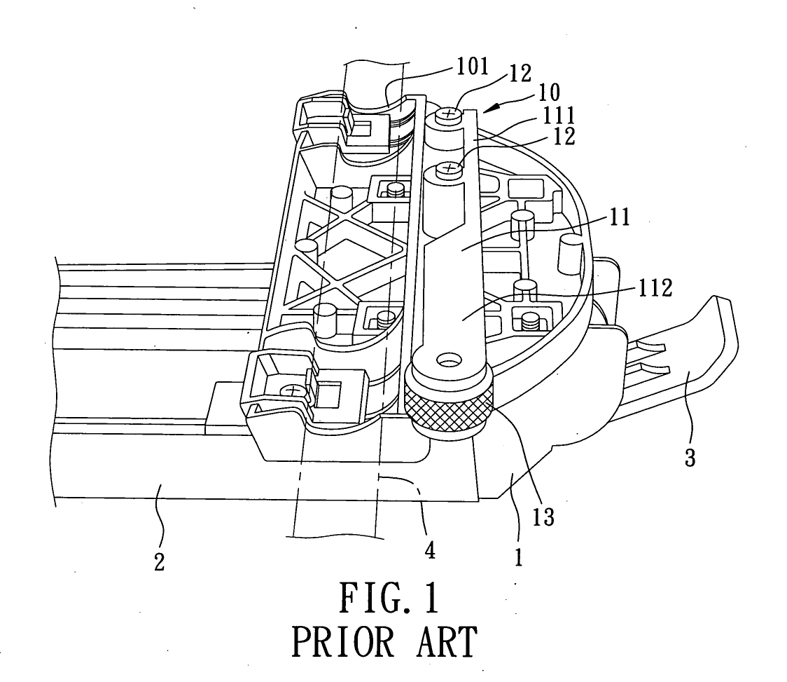

FIG. 2 is a schematic side view of the preferred embodiment of a micro-adjustable fence device according to this invention when mounted on a table saw;

FIG. 3 is a bottom exploded perspective view of a micro-adjusting mechanism of the preferred embodiment;

FIG. 4 is a bottom perspective view of the micro-adjusting mechanism of the preferred embodiment;

FIG. 5 is a fragmentary sectional view of the micro-adjusting mechanism of the preferred embodiment;

FIG. 6 is a schematic view of the preferred embodiment, showing a wheel of the micro-adjusting mechanism in an idle position; and

FIG. 7 is a schematic view of the preferred embodiment, showing the wheel of the micro-adjusting mechanism in a traction gaining position.

### DETAILED DESCRIPTION OF THE PREFERRED EMBODIMENT

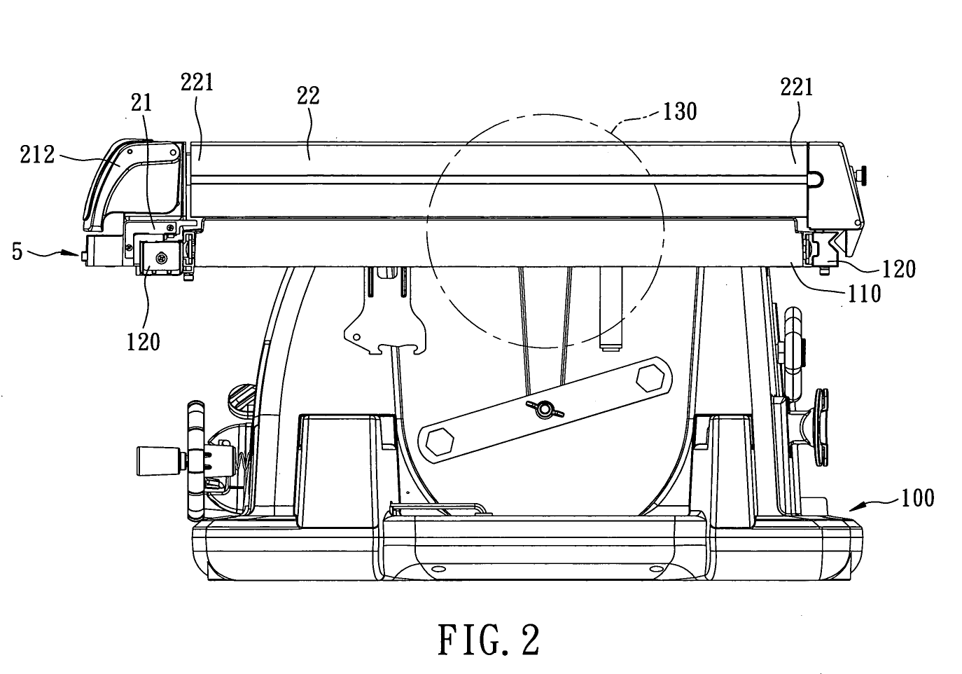

Referring to FIG. 2, the preferred embodiment of a micro-adjustable fence device according to the present invention is shown to be mounted on a cutting machine, such as a table saw 100. The table saw 100 has a tabletop 110 for supporting a workpiece (not shown) thereon, which is to be fed along a feeding path in a first transverse direction transverse to a rotating axis of a cutter, such as a circular saw 130, and a pair of guiding rails 120 which are respectively disposed below front and rear sides of the tabletop 110, and which extend in a longitudinal direction parallel to the rotating axis of the circular saw 130. The fence device of this invention comprises a fence 22, a carriage 21, and a micro-adjusting mechanism 5.

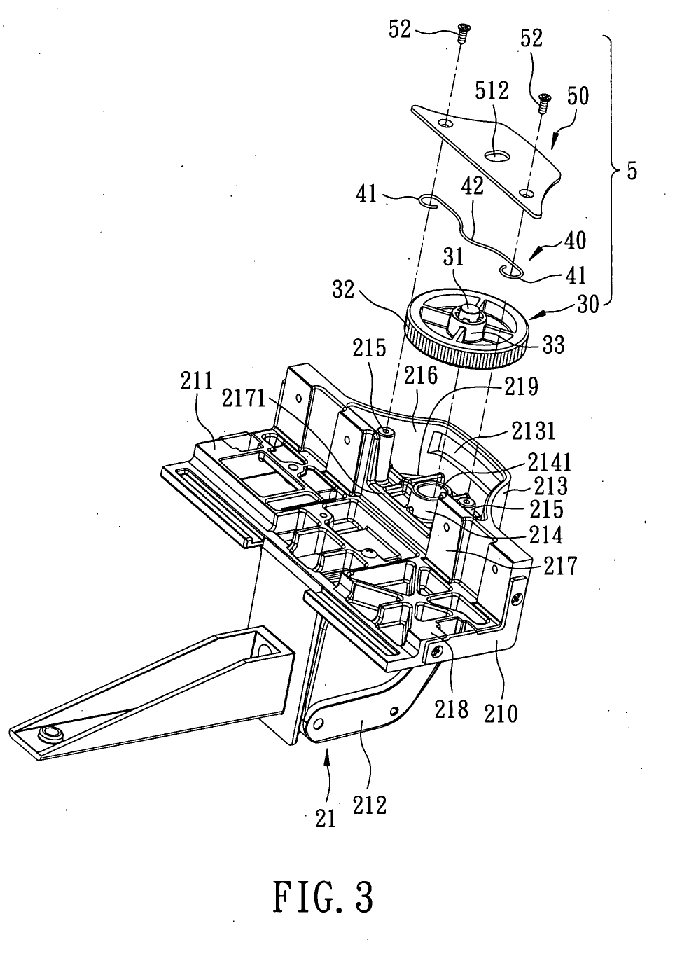

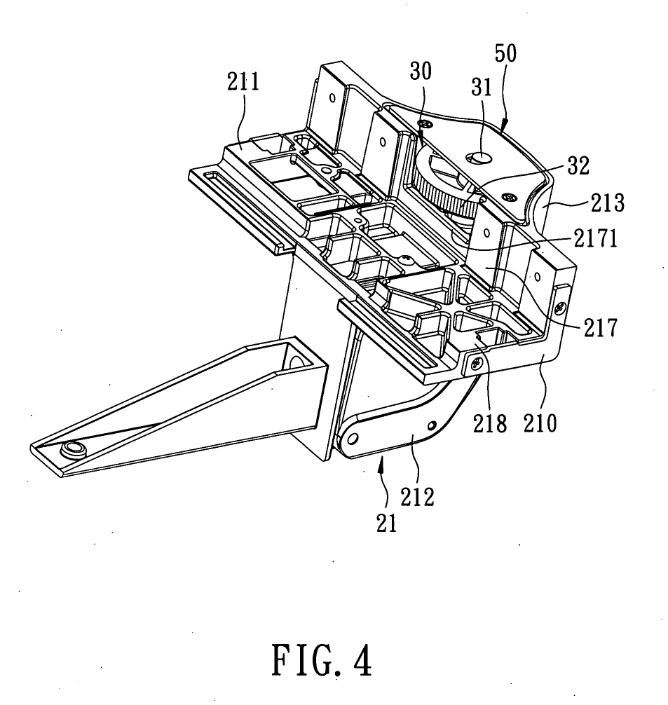

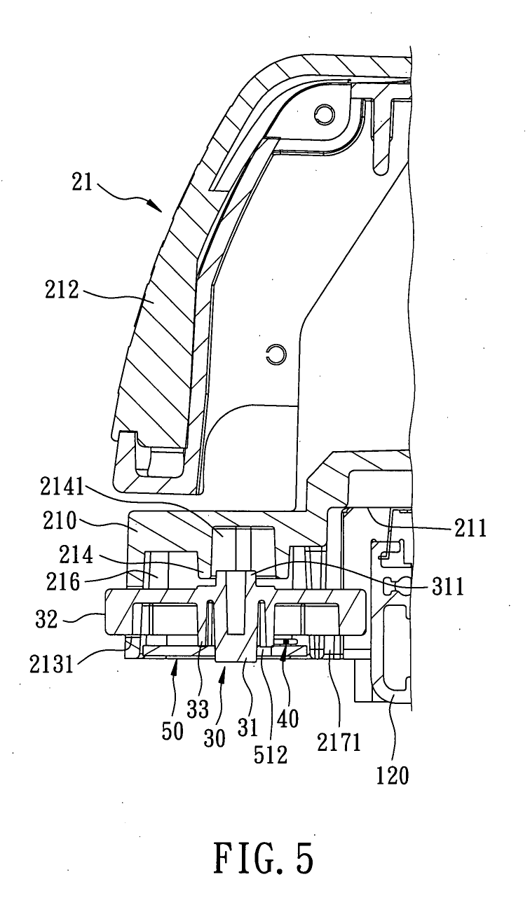

With reference to FIGS. 3 to 5, the fence 22 has front and rear ends 221 opposite to each other in the first transverse direction, and is movable in the longitudinal direction.

The carriage 21 is mounted to the fence 22 proximate to the front end 221, and has a chassis body 210 which has a handle 212 and a downwardly facing major wall surface 218 disposed at upper and lower portions, respectively. The major wall surface 218 is adapted to confront the front guiding rail 120 in a second transverse direction transverse to both the first transverse direction and the longitudinal direction. The major wall surface 218 extends in the first transverse direction and forwardly of the front guiding rail 120 to terminate at a fore end 219. A front upright wall 213 extends in the second transverse direction from the fore end 219, and has an operating opening 2131 formed therethrough. A partition wall 217 extends from the major wall surface 218 in the second transverse direction such that the partition wall 217 cooperates with the major wall surface 218 to define a riding route 211 that extends in the longitudinal direction to guide the major wall surface 218 to slidably ride on the guiding rail 120 so as to permit movement of the fence 22 in the longitudinal direction. Additionally, the partition wall 217 cooperates with the front upright wall 213 to define a mounting chamber 216 for receiving the micro-adjusting mechanism 5. The partition wall 217 has a passage 2171 which extends therethrough in the first transverse direction to communicate the mounting chamber 216 with the riding route 211.

The major wall surface 218 in the mounting chamber 216 further extends in the longitudinal direction to terminate at left and right sides. A tubular post 214 is disposed in a central area of the mounting chamber 216, and has a guiding slot 2141 which extends along an advancing path that defines a straight line in the first transverse direction and normal to the riding route 211. Two anchoring posts 215 are disposed at front and rear sides of the major wall surface 218, and are equally distant from the tubular post 214.

The micro-adjusting mechanism 5 includes a wheel 30, a biasing member 40, and a cover plate 50. The wheel 30 includes a spindle 31 which extends in the second transverse direction, a hub 33 which surrounds the spindle 31 and which defines a hub center in a rotating axis in the second transverse direction, and a rim 32 which is manually turnable about the rotating axis. The spindle 31 extends outwardly of the hub 33 to form a key end 311 that is rotatable and that is guided to move in the guiding slot 2141. The rim 32 is configured to be serrated, and extends beyond the front upright wall 213 through the operating opening 2131 to facilitate operation.

The biasing member 40 is a wire spring 40 which has two secured ends 41 that are respectively secured to the anchoring posts 215, and a middle biasing portion 42 that is interposed between the secured ends 41 and that engages the hub 33 so as to bias the hub 33 away from the guiding rail 120.

The cover plate 50 is disposed to cover the mounting chamber 216, and is secured to the anchoring posts 215 by means of two screw fasteners 52. The cover plate 51 has a guiding hole 512 which extends therethrough and along the advancing path such that the spindle 31 extends through and is movable relative to the guiding hole 512.

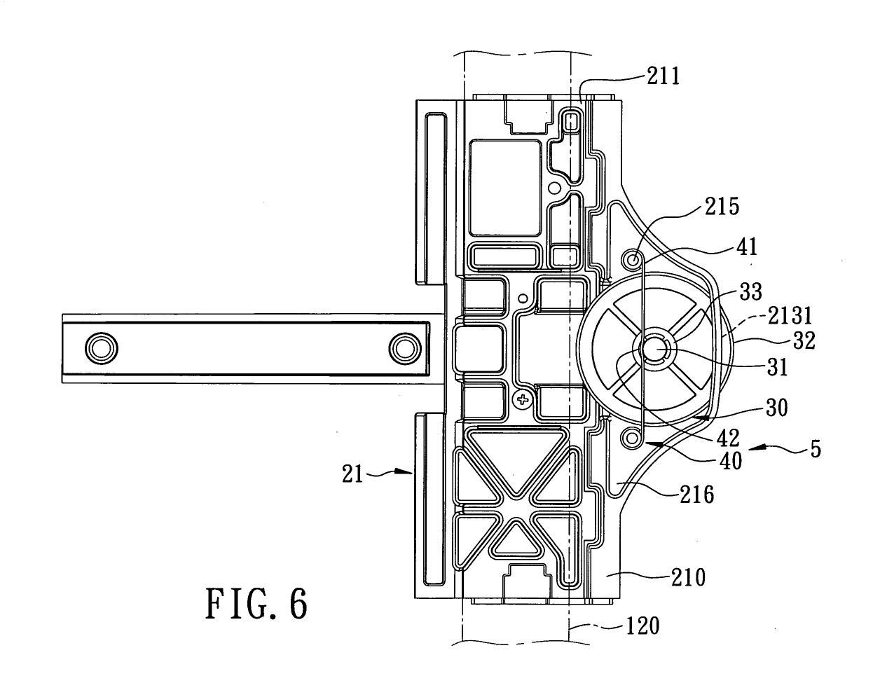

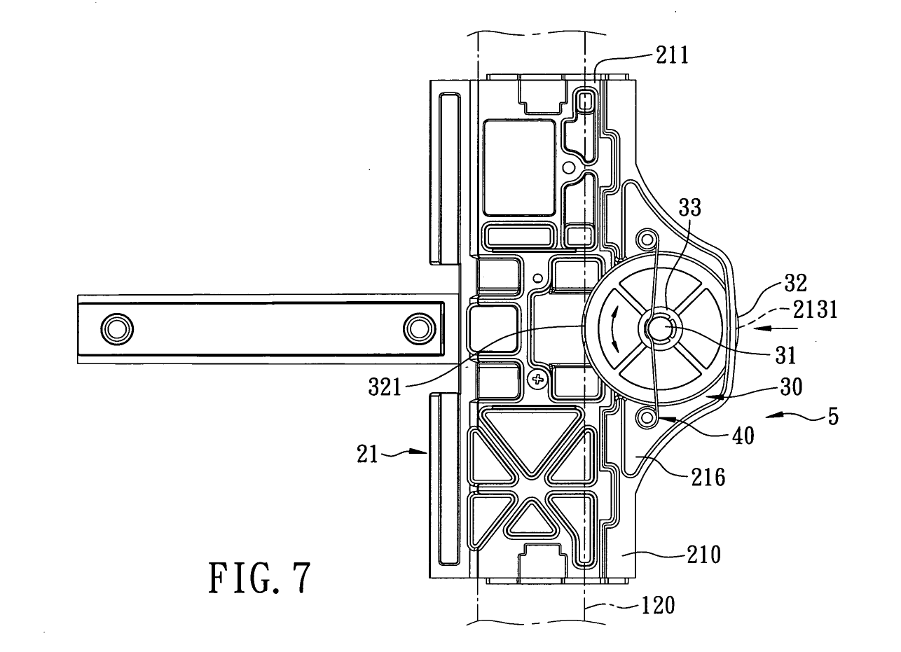

Referring to FIG. 6, when the micro-adjusting mechanism 5 is not operated, the wheel 30 is biased by the wire spring 40 to an idle position, where the rim 32 is disengaged from the front guiding rail 120. Referring to FIG. 7, when it is desired to conduct micro-adjustment of the fence device, the operator pushes a portion of the rim 32 that extends through the operating opening 2131 towards the front guiding rail 120 such that the spindle 31 is moved along the guiding slot 2141 to a traction gaining position, where the rim 32 extends through the passage 2171 and frictionally contacts the guiding rail 120 at a tangential point 321. At this time, the operator can rotate the rim 32 about the rotating axis with the hand that pushes the rim 32 so as to permit the rim 32 to roll on the front guiding rail 120, thereby moving the fence 22 to a finely adjusted position.

As illustrated, since the wheel 30 is disposed in a middle area of the mounting chamber 216, and since the hub 33 is engaged with the middle biasing portion 42 of the biasing member 40, the user can operate the portion of the rim 32 that extends beyond the operating opening 2131 so as to move the hub center along the straight advancing path, rather than along an angular path like that of the aforesaid conventional wheel 13. Thus, the tangential point 321 of the rim 32 is in line with the advancing path of the hub center when the rim 32 shifts from the idle position to the traction gaining position. Subsequently, the user can rotate the rim 32 at the portion which extends beyond the operating opening 2131 to move the entire fence device along the guiding rails 120 to a desired position of adjustment. Thus, the micro-adjusting operation is easy to conduct. Additionally, the force generated as a result of the micro-adjusting operation of the wheel 30 can be evenly applied to the carriage 21 to prevent tilting of the carriage 21, thereby resulting in smooth movement of the fence device along the guiding rails 120. Moreover, the biasing force of the biasing member 40 can evenly bias the wheel 30 due to engagement of the middle biasing portion 42 with the hub 33. While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A micro-adjustable fence device for a cutting machine which has a tabletop for supporting a workpiece that is to be fed along a feeding path in a first transverse direction transverse to a rotating axis of a cutter, and a guiding rail disposed below the tabletop and extending in a longitudinal direction parallel to the rotating axis, said fence device comprising:
a fence which has front and rear ends opposite to each other in the first transverse direction, and which is movable in the longitudinal direction;
a carriage mounted to said fence proximate to said front end, and having a chassis body which has a major wall surface that is adapted to confront the guiding rail in a second transverse direction transverse to both the first transverse direction and the longitudinal direction, said major wall surface extending in the first transverse direction and forwardly of the guiding rail to terminate at a fore end, said major wall surface having a riding route therein which extends in the longitudinal direction, and which is adapted to guide said major wall surface to slidably ride on the guiding rail so as to permit movement of said fence in the longitudinal direction;
a wheel including a hub that is rotatably mounted relative to said chassis body about a rotating axis in the second transverse direction, and that defines a hub center in the rotating axis, and a rim that is manually turnable about the rotating axis, and that is disposed to be shiftable between a traction gaining position, where said rim frictionally contacts the guiding rail at a tangential point so as to roll thereon, thereby moving said fence to a finely adjusted position, and an idle position, where said rim is disengaged from the guiding rail, said wheel being disposed proximate to said fore end such that said tangential point is in line with an advancing path of said hub center when said rim shifts from the idle position to the traction gaining position; and
a biasing member disposed to bias said hub to move towards the idle position.

2. The micro-adjustable fence device according to claim 1, wherein the advancing path of said hub center defines a straight line in the first transverse direction and normal to the riding route.

3. The micro-adjustable fence device according to claim 1, wherein said major wall surface further extends in the longitudinal direction to terminate at left and right sides, said biasing member being a wire spring which has two secured ends that are respectively secured to said left and right sides, and a middle biasing portion that is interposed between said secured ends and that engages said hub so as to bias said hub away from the guiding rail.

4. The micro-adjustable fence device according to claim 1, wherein said carriage has a partition wall which extends from said major wall surface in the second transverse direction, which cooperates with said major wall surface to define the riding route, and which cooperates with said fore end to define a mounting chamber for receiving said wheel and said biasing member.

5. The micro-adjustable fence device according to claim 4, wherein said carriage has a tubular post which is disposed in said mounting chamber and which has a guiding slot that extends along the advancing path, said wheel having a spindle which is surrounded by said hub and which extends in the second transverse direction and outwardly of said hub to form a key end that is rotatable and that is guided to move in said guiding slot.

6. The micro-adjustable fence device according to claim 5, wherein said partition wall has a passage which extends therethrough along the advancing path to communicate said mounting chamber with said riding route so as to permit said rim to be shifted to the traction gaining position.

7. The micro-adjustable fence device according to claim 5, further comprising a cover plate which is disposed to cover said mounting chamber, and which has a guiding hole that extends therethrough and along the advancing path such that said spindle extends through and is movable relative to said guiding hole.

8. The micro-adjustable fence device according to claim 1, wherein said rim is configured to be serrated, and which extends beyond said fore end to facilitate operation.
